(19) United States
(12) Patent Application Publication
(10) Pub. No.: US 2003/0200858 A1
(43) Pub. Date: Oct. 30, 2003

(54) Mixing MP3 audio and T T P for enhanced E-book application

(76) Inventor: Jianlei Xie, Camel, IN (US)

Correspondence Address: JOSEPH S. TRIPOLI, THOMSON MULTIMEDIA LICENSING INC., 2 INDEPENDENCE WAY, P. O. BOX 5312, PRINCETON, NJ, 08543-5312, US

(21) Appl. No.: 10/135,151

(22) Filed: Apr. 29, 2002

(51) Int. Cl. G10H 1/26

(52) U.S. Cl. 84/609

(57) ABSTRACT

There is provided an Ebook. The Ebook includes a memory device, a text-to-speech (TTS) module, and a music module. The memory device stores files. The files include text and music. The TTS module synthesizes speech corresponding to the text. The music module plays back the music. The at least one speaker outputs the speech and the music.

### CROSS-REFERENCE TO RELATED APPLICATIONS

This application is related to the applications, Attorney Docket Numbers IU000025, IU010084, and IU010085, respectively entitled “Talking Ebook”, “Text-To-Speech (TTS) for Hand-Held Devices”, and “Voice Command and Voice Recognition for Hand-Held Devices”, which are commonly assigned and concurrently filed herewith, and the disclosures of which are incorporated herein by reference.

### BACKGROUND OF THE INVENTION

1. Field of the Invention

The present invention generally relates to hand-held devices and, more particularly, to mixing music and text-to-speech (TTS) for hand-held devices.

2. Background of the Invention

An electronic book (also referred to as an “Ebook”) is an electronic version of a traditional print book (or other printed material such as, for example, a magazine, newspaper, and so forth) that can be read by using a personal computer or by using an Ebook reader. Unlike PCs or handheld computers, Ebook readers deliver a reading experience comparable to traditional paper books, while adding powerful electronic features for note taking, fast navigation, and key word searches. However, such actions, irrespective of whether or not they are performed on a PC, handheld computer, or Ebook reader, generally require the user to read the text from a display. Thus, the use of an Ebook generally requires the user to focus his or her visual attention on a display to read the text content (e.g., book, magazine, newspaper, and so forth) of the Ebook. Moreover, reading of an Ebook is generally performed without any music playing in the background, particularly without any music playing from the Ebook itself. The same is true for other types of hand-held devices such as personal digital assistants (PDAs) and so forth.

Accordingly, it would be desirable and highly advantageous to have a hand-held device such as, for example, an Ebook, that allows a user to assimilate content without having to look at a display. Moreover, it would be desirable and highly advantageous to have such a hand-held device that further allows a user to listen to background music while assimilating the content.

### SUMMARY OF THE INVENTION

The problems stated above, as well as other related problems of the prior art, are solved by the present invention, a hand-held device having music and text-to-speech capabilities.

According to an aspect of the present invention, there is provided an Ebook. The Ebook comprises a memory device, a text-to-speech (TTS) module, and a music module. The memory device stores files. The files include text and music. The TTS module synthesizes speech corresponding to the text. The music module plays back the music. The at least one speaker outputs the speech and the music.

According to another aspect of the present invention, there is provided a method for using an Ebook. At least one file is stored in the Ebook. The at least one file includes text and music. Speech corresponding to the text is synthesized. The music is played back. The speech and the music are output.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a block diagram illustrating a computer system 100 to which the present invention may be applied, according to an illustrative embodiment of the present invention;

FIG. 2 is a block diagram illustrating an Ebook 200, according to an illustrative embodiment of the present invention;

FIG. 3 is a flow diagram illustrating a method for using an Ebook having music and text-to-speech (TTS) capabilities, according to an illustrative embodiment of the present invention; and

FIG. 4 is a flow diagram further illustrating steps 330 and 340 of the method of FIG. 3, according to an illustrative embodiment of the present invention.

### DETAILED DESCRIPTION OF THE INVENTION

The present invention is directed to a hand-held device having music and text-to-speech (TTS) capabilities. It is to be appreciated that the present invention is directed to any type of hand-held device including, but not limited to, electronic books (Ebooks), personal digital assistants (PDAs), and so forth. However, for the purposes of describing the present invention, the following description will be provided with respect to Ebooks.

Music capabilities allow an Ebook user to enjoy digital music output from the Ebook. TTS capabilities allow an Ebook user to listen to synthesized text output from the Ebook. The combination of music and TTS allow an Ebook user to listen to the text along with background music.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

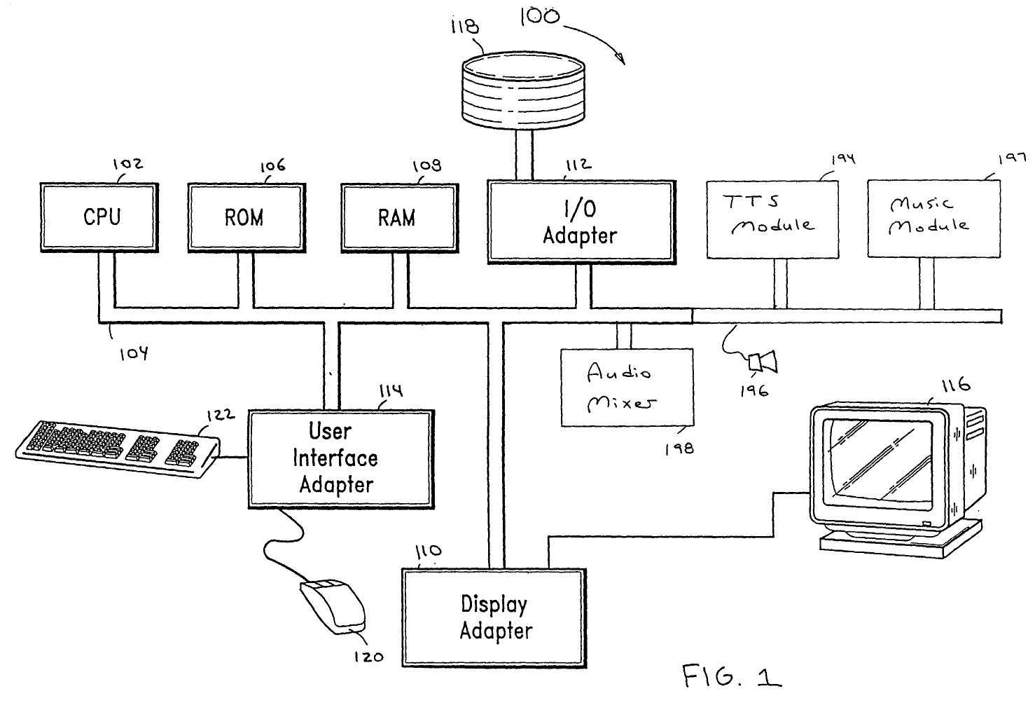

FIG. 1 is a block diagram illustrating a computer system 100 to which the present invention may be applied, according to an illustrative embodiment of the present invention. The computer processing system 100 includes at least one processor (CPU) 102 operatively coupled to other components via a system bus 104. A read only memory (ROM) 106, a random access memory (RAM) 108, a display adapter 110, an 1/0 adapter 112, and a user interface adapter 114 are operatively coupled to the system bus 104.

A display device 116 is operatively coupled to system bus 104 by display adapter 110. A disk storage device (e.g., a magnetic or optical disk storage device) 118 is operatively coupled to system bus 104 by I/O adapter 112.

A mouse 120 and keyboard 122 are operatively coupled to system bus 104 by user interface adapter 114. The mouse 120 and keyboard 122 are used to input and output information to and from system 100.

The computer system 100 further includes a text-to-speech (TTS) module 194, a speaker 196, a music module 197; and an audio mixer 198.

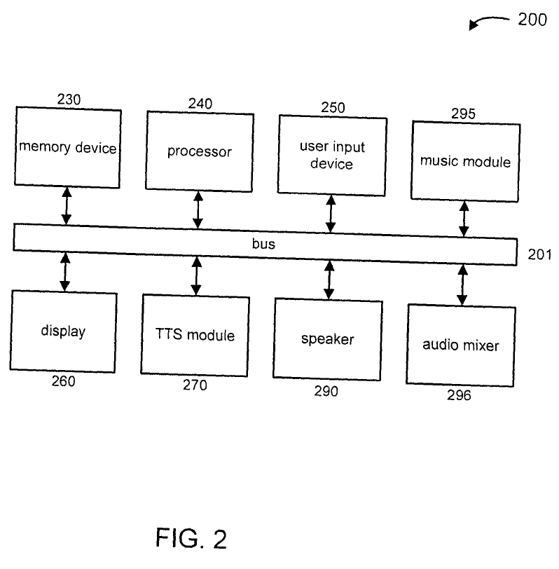

FIG. 2 is a block diagram illustrating an Ebook 200, according to an illustrative embodiment of the present invention. The Ebook 200 includes the following elements interconnected by bus 201: at least one memory device (hereinafter “memory device” 230); at least one processor (hereinafter “processor” 240); a user input device 250 (e.g., keyboard, keypad, and/or remote control); a display 260; a text-to-speech (TTS) module 270; a speaker 290; a music module (e.g., MP3) 295; and an audio mixer 296.

The functionality of the music modules 197, 295 and any components included therein depend on the type of music format to be played on the Ebook. At the least, the music modules 197, 295 are capable of playing back at least one type of music format. However, it is preferable if the music modules 197, 295 are capable of playing back more than one type of music format. Further, it is preferable if the music modules 197, 295 are capable of controlling/adjusting parameters of the music. It is to be appreciated that the control/adjustment of music parameters may be performed solely by the music modules 197, 295 or may be shared with and/or performed solely by other elements of the Ebook (e.g., processors 102, 240). Moreover, it is to be further appreciated that the control/adjustment of parameters associated with speech synthesis may be performed solely by the TTS modules 194, 270 or may be shared with and/or performed solely by other elements of the Ebook (e.g., processors 102, 240). Given the teachings of the present invention provided herein, one of ordinary skill in the related art will contemplate these and various other configurations of the computer system 100 and Ebook 200 respectively shown in FIGS. 1 and 2 (as well as the elements respectively corresponding thereto), while maintaining the spirit and scope of the present invention. It is to be appreciated that as used herein the term “Ebook” refers to either a standalone Ebook device (e.g., Ebook 200) or an Ebook included in a computer system (e.g., computer system 100).

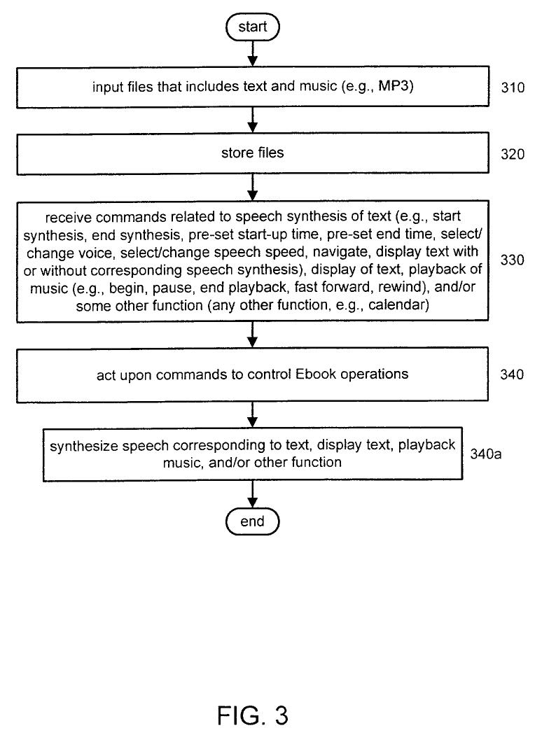

FIG. 3 is a flow diagram illustrating a method for using an Ebook having music and text-to-speech (TTS) capabilities, according to an illustrative embodiment of the present invention.

One or more files (hereinafter “files) are input into the Ebook (step 310). The files include at least text and music. For example, one of the files may be a text file and another file may be an MP3 or other type of music/audio file (e.g., WAV files, and so forth). Of course, either file may include other information (e.g., graphics, and so forth). Moreover, the text and music could be included in the same file. The files may be provided via a memory device (e.g., floppy disk, compact disk, flash memory, and so forth), downloaded from the Internet, and/or through any other means. The files are then stored in the Ebook (step 320).

One or more commands are received by the Ebook (step 330). At least one of the commands may correspond to a playback of a file that includes text to be reproduced by the Ebook. For example, at least one of the commands may be: a command to begin synthesizing speech corresponding to the text included in the file so that the text is reproduced audibly; a command to end the synthesis; a command to preset a start-up time and/or an end time for the speech synthesis; a command to select/change a voice(s) used in the speech synthesis; a command to select/change the speed of the synthesized speech; a command corresponding to navigation through the file (e.g., to skip one or more pages, sections, chapters, and so forth); and so forth. As used herein, the preceding commands may be considered to correspond to parameters of speech synthesis. It is to be appreciated that the commands corresponding to text may also include a command to display the text in place of, or concurrently with, the synthesis of speech corresponding to the text.

Moreover, at least one of the commands may correspond to the playback of a file that includes music (e.g., MP3 file, WAV file, and so forth). For example, at least one of the commands may be: a command to begin, pause, or end playback of the music; a command to fast forward or rewind; and so forth.

Further, it is to be appreciated that some of the commands received at step 330 may not correspond to the playback of a file that includes at least one of text and music for playback. For example, if other functions are integrated with the Ebook such as, for example, a calendar function with a daily reminder schedule, then information relating to the calendar function (or any other function) may be received by the Ebook.

The commands are then acted upon to control operations of the Ebook (step 340). Step 340 may include the step of synthesizing speech corresponding to the text, displaying the text, playing back music, and/or some other function (step 340a). The music may be played back either in the foreground (i.e., no other function currently active) or in the background (i.e., at least one other function currently active)).

It is to be appreciated that in the event that both speech synthesis and music playback are simultaneously requested, then a first audio output that includes the synthesized text is mixed with a second audio output that includes the reproduced music. It is the mixed audio output that is provided to a user of the Ebook. Advantageously, the first and second audio outputs can be controlled/adjusted prior to mixing, based on user-specified selections, a random basis, and/or parameters of a current one of the files. Thus, the audio corresponding to the text and the music may be independently controlled. Of course, other arrangements are possible, including mixing the speech and music prior to control/adjustment of any parameters corresponding to the speech and music.

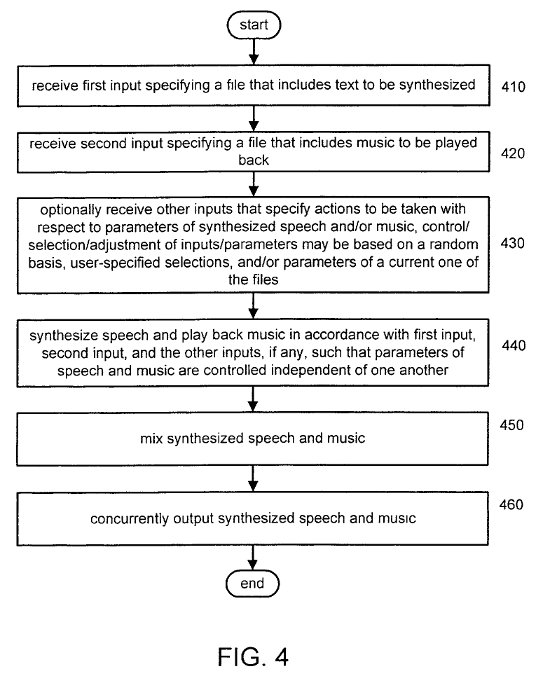

FIG. 4 is a flow diagram further illustrating steps 330 and 340 of the method of FIG. 3, according to an illustrative embodiment of the present invention. The example of FIG. 4 corresponds to the case when a user of the Ebook wants to, at the least, listen to text while music is played in the background.

A first input is received specifying a file that includes text to be synthesized and audibly provided to the user (step 410). A second input is received specifying a file that includes music to be audibly provided to the user (step 420). The file specified at step 410 may be the same or a different file from that specified at step 420.

Optionally, other inputs may be received that specify actions to be taken with respect to parameters of the synthesized speech and/or music (step 430). Such parameters, may include, but are not limited to the following: the speed of the synthesized speech and/or the music; the volume of the synthesized speech and/or music; the voice(s) used in the speech synthesis; navigation through music (e.g., fast forward, rewind, etc.) and/or the text corresponding to the synthesized speech (e.g., skip page, chapter, section, etc.); and so forth. It is to be appreciated that steps 420 through 430 may be performed randomly by the Ebook. Alternatively, all (or some combination amounting to less than all) of the inputs may be user provided. That is, the inputs as well as the parameters may be controlled/selected/adjusted based on a random basis, user-specified selections, and/or parameters of a current one of the files.

Then, the speech is synthesized and the music is played back in accordance with the first input, the second input, and the other inputs, if any, such that the parameters of the speech and the music are controlled independent of one another (step 440). The synthesized speech and music are then mixed by the mixer (step 450). The mixed speech and music are then concurrently output by the speaker to a user of the Ebook (step 460).

Although the illustrative embodiments have been described herein with reference to the accompanying drawings, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

What is claimed is:

1. An Ebook, comprising:
a memory device for storing files, the files including text and music;
a text-to-speech (TTS) module for synthesizing speech corresponding to the text;
a music module for playing back the music; and
at least one speaker for outputting the speech and the music.

2. The Ebook of claim 1, further comprising a display for displaying the text.

3. The Ebook of claim 1, wherein said TTS module has a capability of switching between any one of a plurality of voices in synthesizing the speech, based on at least one of a random basis, user-specified selections, and parameters of a current one of the files.

4. The Ebook of claim 1, wherein said TTS module has a capability of controlling a speed of at least one of the speech and the music, based on at least one of a random basis, user-specified selections, and parameters of a current one of the files.

5. The Ebook of claim 4, wherein the speed of the speech and the speed of the music are controlled independent of one another.

6. The Ebook of claim 1, further comprising a processor for controlling a volume of the speech and a volume of the music independent of one another.

7. The Ebook of claim 1, further comprising a mixer for mixing the speech and the music.

8. The Ebook of claim 7, wherein parameters of the speech and the music are controlled prior to the speech and the music being mixed by said mixer.

9. The Ebook of claim 8, wherein the parameters of the speech and the music comprise at least one of a speed of the speech, a speed of the music, a volume of the speech, and a volume of the music.

10. The Ebook of claim 1, wherein the music corresponds to the Motion Pictures Experts Group Level 3 (MP3) standard.

11. A method for using an Ebook, comprising the steps of:
storing at least one file in the Ebook, the at least one file including text and music;
synthesizing speech corresponding to the text;
playing back the music; and
outputting the speech and the music.

12. The method of claim 11, further comprising the step of displaying the text.

13. The method of claim 11, further comprising the step of switching between any one of a plurality of voices in synthesizing the speech, based on at least one of a random basis, user-specified selections, and parameters of a current one of the files.

14. The method of claim 11, further comprising the step of controlling a speed of at least one of the speech and the music, based on at least one of a random basis, user-specified selections, and parameters of a current one of the files.

15. The method of claim 14, wherein the speed of the speech and the speed of the music are controlled independent of one another.

16. The method of claim 11, further comprising the step of controlling a volume of the speech and the volume of the music independent of one another.

17. The method of claim 11, further comprising the step of mixing the speech and the music.

18. The method of claim 17, further comprising the step of controlling parameters of the speech and the music prior to said mixing step.

19. The method of claim 18, wherein the parameters of the speech and the music comprise at least one of a speed of the speech, a speed of the music, a volume of the speech, and a volume of the music.

20. The method of claim 11, wherein the music corresponds to the Motion Pictures Experts Group Level 3 (MP3) standard.

21. A hand-held device, comprising:
a memory device for storing files, the files including text and music;
a text-to-speech (TTS) module for synthesizing speech corresponding to the text;
a music module for playing back the music; and
at least one speaker for outputting the speech and the music.

22. The hand-held device of claim 21, wherein said TTS module has a capability of switching between any one of a plurality of voices in synthesizing the speech, based on at least one of a random basis, user-specified selections, and parameters of a current one of the files.

23. The hand-held device of claim 21, wherein said TTS module has a capability of controlling a speed of a t least one of the speech and the music, based on at least one of a random basis, user-specified selections, and parameters of a current one of the files.

24. The hand-held device of claim 23, wherein the speed of the speech and the speed of the music are controlled independent of one another.

25. The hand-held device of claim 21, further comprising a mixer for mixing the speech and the music.

26. The hand-held device of claim 25, wherein parameters of the speech and the music are controlled prior to the speech and the music being mixed by said mixer.
